(19) United States
(12) Patent Application Publication
(10) Pub. No.: US 2020/0022333 A1
(43) Pub. Date: Jan. 23, 2020

(54) AUTOMATED FEEDER FOR LIVE BAIT

(71) Applicants: Brandon Alan Smith, Dalton, GA (US); Felicia Caid Smith, Dalton, GA (US)

(72) Inventors: Brandon Alan Smith, Dalton, GA (US); Felicia Caid Smith, Dalton, GA (US)

(21) Appl. No.: 16/518,975

(22) Filed: Jul. 22, 2019

Related U.S. Application Data
(60) Provisional application No. 62/701,109, filed on Jul. 20, 2018.

(51) Int. Cl. A01K 5/02

(52) U.S. Cl. CPC A01K 5/0291; A01K 5/0114

(57) ABSTRACT

Implementations of an automated feeder for live bait are provided. In some implementations, the automated feeder for live bait comprises a plurality of storage units configured to house live bait such as crickets, worms, roaches, etc., wherein each storage unit comprises an automated door that is configured to open and close.

In some implementations, a method of using the automated feeder for live bait comprises loading the storage units with live bait, and feeding the loaded live bait from the storage units to a pet at a pre-programmed time, wherein the method is performed remotely using a mobile application on a portable computing device (or a software application on a desktop computing device) or locally using a local user interface on the automated feeder for live bait.

### CROSS REFERENCE TO RELATED APPLICATION

This application claims the benefit of U.S. Patent Application Ser. No. 62/701,109, which was filed on Jul. 20, 2018, and is incorporated herein by reference in its entirety.

### TECHNICAL FIELD

This disclosure relates to implementations of an automated feeder for live bait.

### BACKGROUND

Pet reptiles may be fed live bait. For example, bearded dragon lizards are typically fed crickets. Similarly, other types of pets, such as amphibians or birds, may be fed live bait, such as crickets, worms, roaches, etc. These pets may be fed such live bait regularly (e.g., daily or multiple times a day). However, there does not exist any automated feeders to house and release such live bait to feed such pets if the owner or other caretaker is away on vacation or otherwise unavailable.

### BRIEF DESCRIPTION OF THE DRAWINGS

FIG. 1 illustrates an implementation of an example environment of an automated feeder for live bait according to the present disclosure.

FIG. 2 illustrates an example computer system, which may be used with implementations of the present disclosure.

FIGS. 3A-3E illustrate various front views of an implementation of an example automated feeder for live bait according to the present disclosure.

FIGS. 3F-3G illustrate various back views of the example automated feeder for live bait according to the present disclosure.

FIGS. 3H-3J illustrate various views of an example top piece of the automated feeder for live bait according to the present disclosure.

FIGS. 3K-3O illustrate various views of an example sub-top piece of the automated feeder for live bait according to the present disclosure.

FIGS. 3P-3R illustrate various views of an example bottom piece of the automated feeder for live bait according to the present disclosure.

FIGS. 4A-4C illustrate implementations of example user interfaces of a mobile application for controlling an automated feeder for live bait according to the present disclosure.

### DETAILED DESCRIPTION

Implementations of an automated feeder for live bait are provided. In some implementations, the automated feeder for live bait comprises a plurality of storage units configured to house live bait such as crickets, worms, roaches, etc., wherein each storage unit comprises an automated door that is configured to open and close.

In some implementations, each of the automated doors is configured to open and/or close in response to activating an actuator on the feeder (e.g., pressing a button) or on a remote controller (e.g., a mobile device, a desktop device, or other remote controller). In some implementations, each of the automated doors is configured to open and/or close based on a pre-programmed time (e.g., based on a programmer installed on the feeder and programmed locally via a user interface on the feeder or based on a remote programmer as discussed below). In some implementations, the automated door can also be preprogrammed to close.

In some implementations, the automated feeder for live bait is configured to house live bait. In some implementations, the automated feeder for live bait is configured to maintain the live bait. In some implementations, the automated feeder for live bait is configured to house food for the live bait.

In some implementations, the automated feeder for live bait is configured so that the live bait cannot exit the automated feeder for live bait unless a respective automated door of one of the storage units is open.

In some implementations, the automated feeder for live bait is configured to be controlled by a mobile application on a portable computing device, such as a mobile phone, or by a software application on a desktop computing device, such as a desktop computer. In some implementations, the automated feeder for live bait is configured to be controlled through a user interface of the mobile application on the portable computing device or the software application on the desktop computing device.

In some implementations, the automated feeder for live bait is configured to be controlled by the mobile application or the software application (collectively “application”) with instructions wirelessly transmitted to the automated feeder for live bait. In some implementations, the automated feeder for live bait is configured to be controlled by the application to operate the automated feeder for live bait. For example, in some implementations, the automated feeder for live bait is configured to be controlled by the application to open or close a respective automated door of one of the storage units.

In some implementations, the automated feeder for live bait is configured to be controlled by the application to program the automated feeder for live bait. In some implementations, the automated feeder for live bait is configured to be programmed by the application to automatically operate the automated feeder for live bait. For example, in some implementations, the automated feeder for live bait is configured to be programmed by the application to automatically open a respective automated door of one of the storage units at a set time. In some implementations, the automated feeder for live bait is configured to be programmed to automatically open the respective automated door to feed the live bait to a reptile or other pet that is fed live bait.

In this way, in some implementations, the automated feeder for live bait houses, maintains, and automatically feeds live bait to a reptile or other pet that is fed live bait when the owner or other caretaker of the pet is away on vacation or otherwise unavailable.

In some implementations, a method of using the automated feeder for live bait comprises loading the storage units with live bait, and feeding the loaded live bait from the storage units to a pet at a pre-programmed time, wherein the method is performed remotely using a mobile application on a portable computing device (or a software application on a desktop computing device) or locally using a local user interface on the automated feeder for live bait.

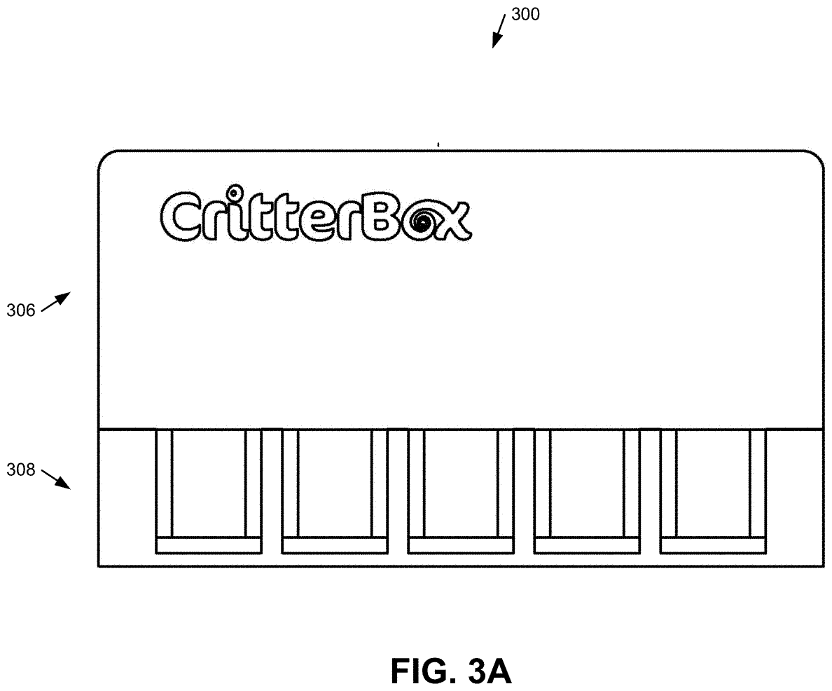

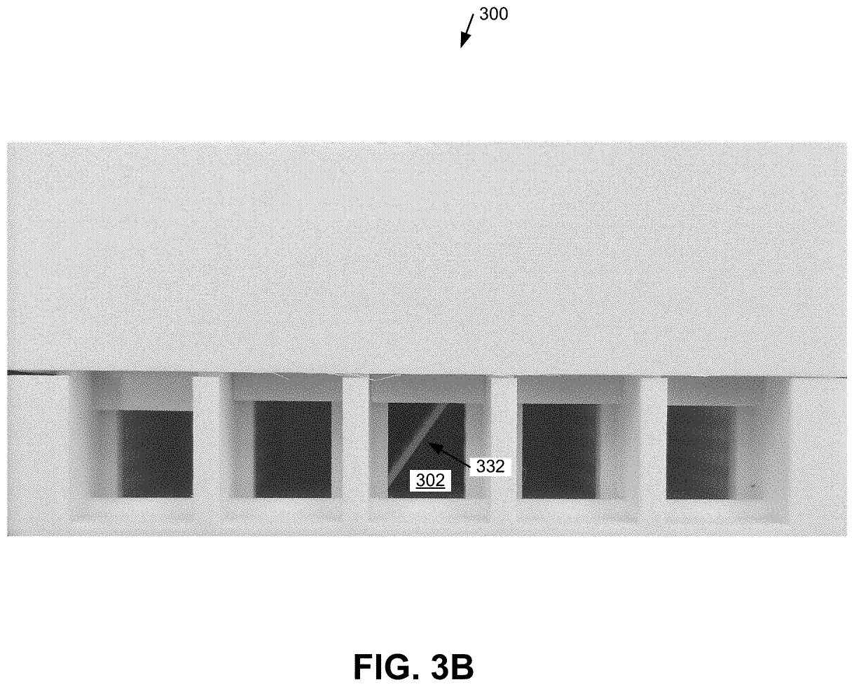

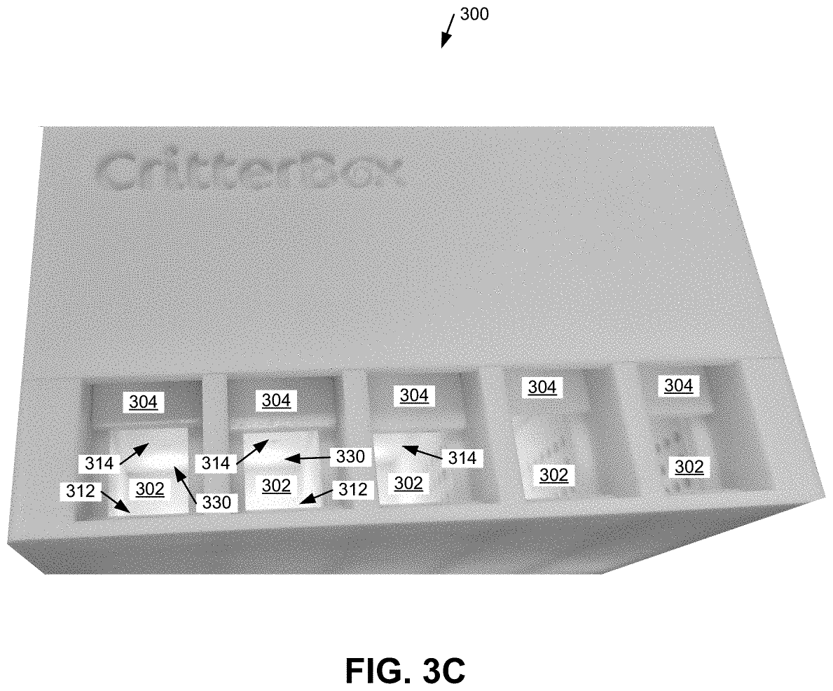

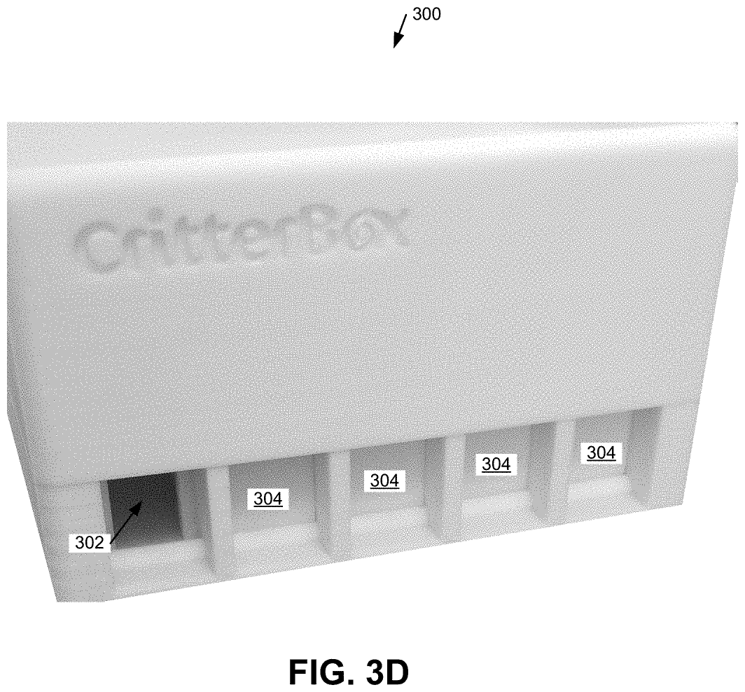

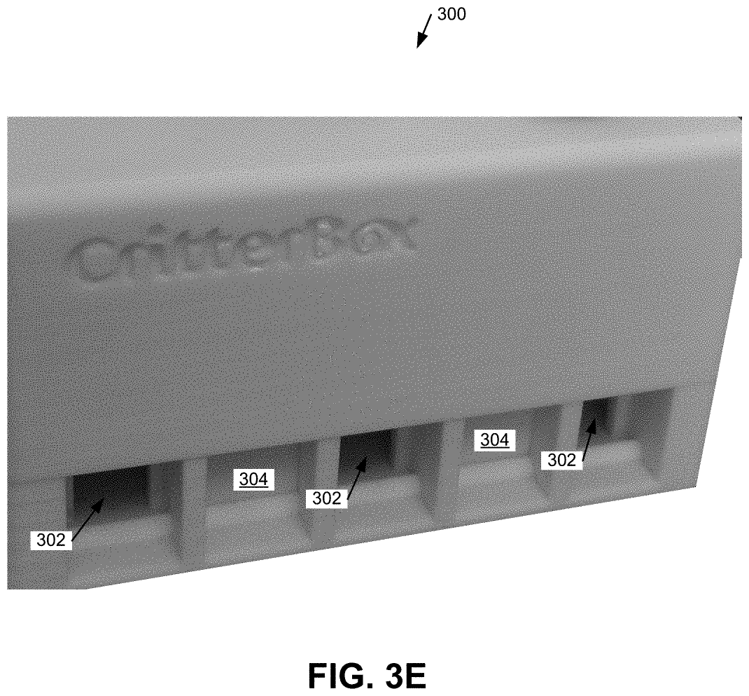

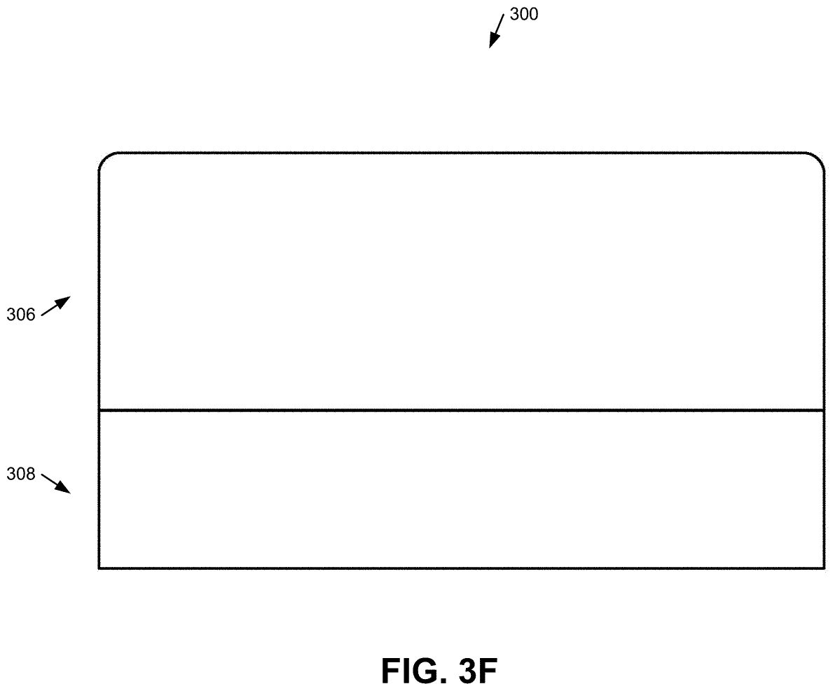

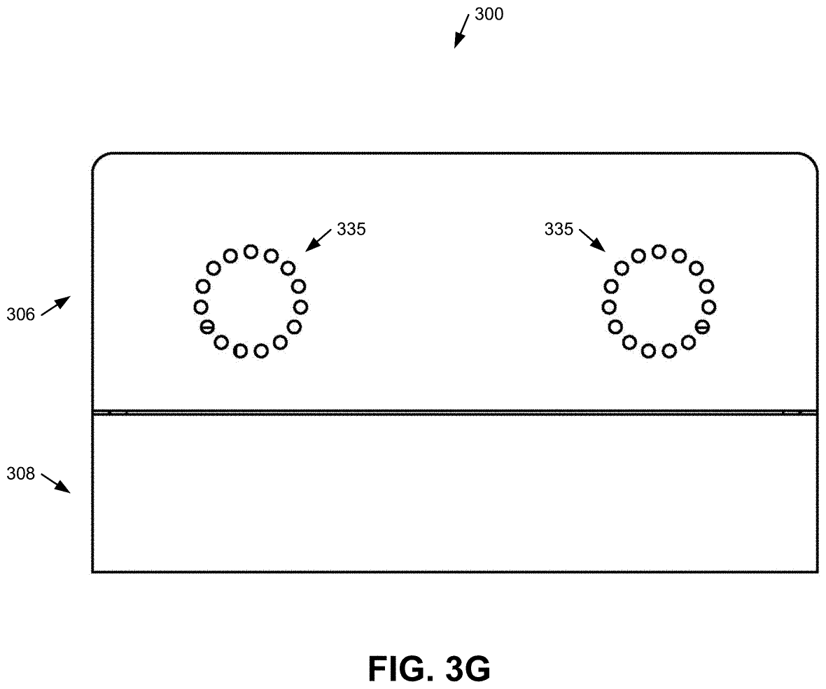

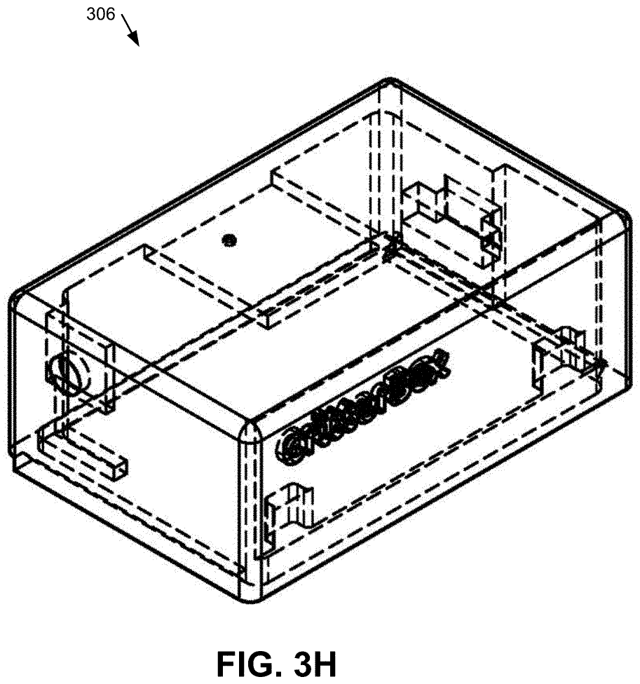

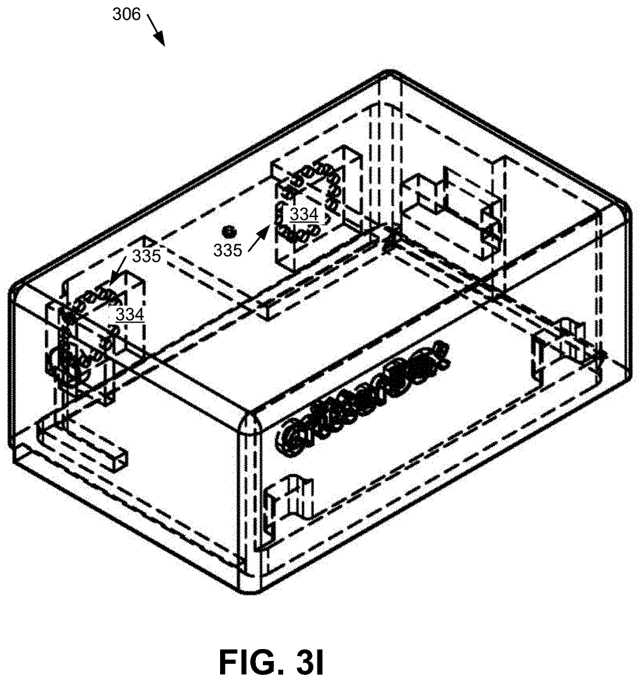

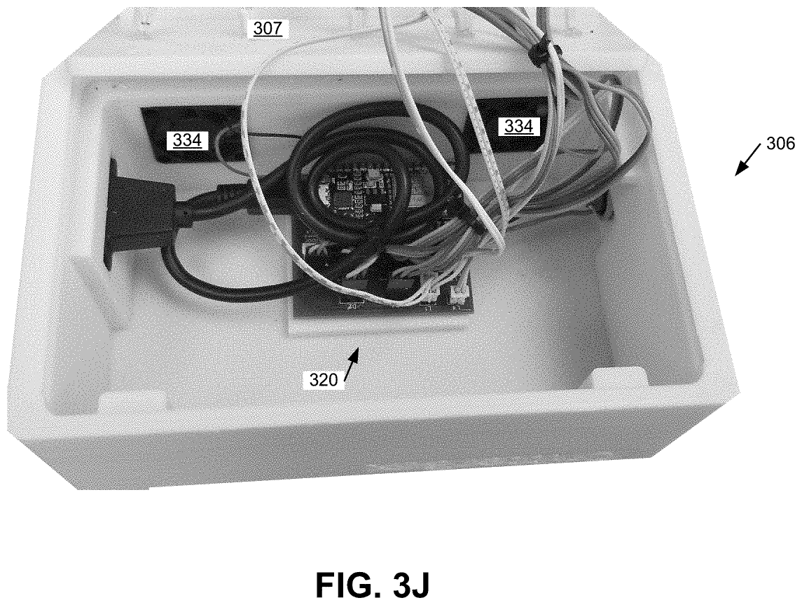

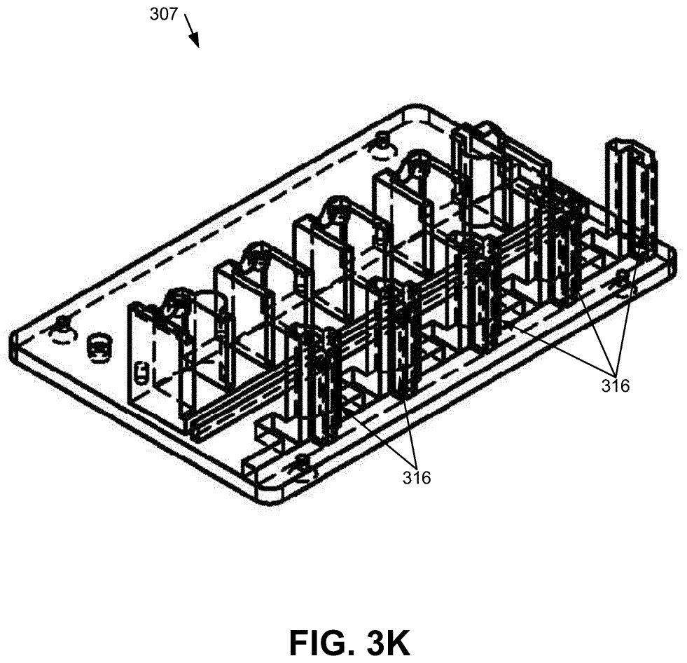

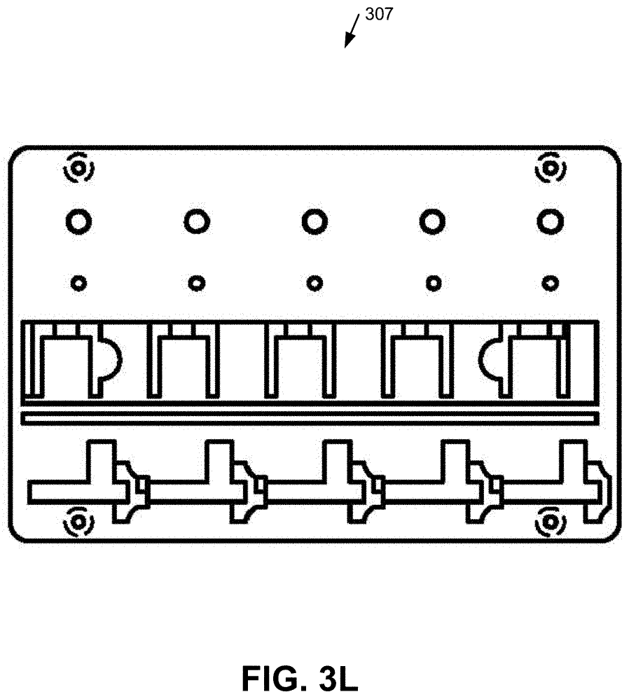

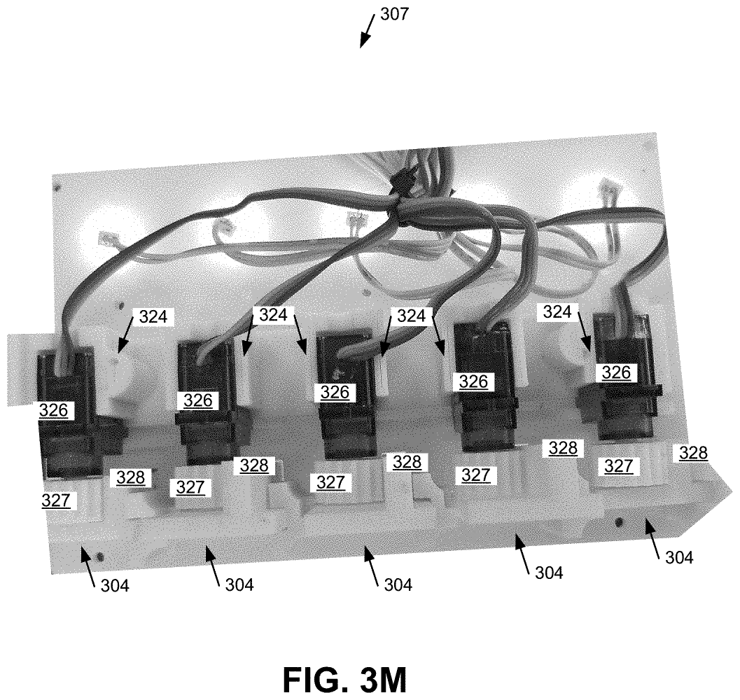

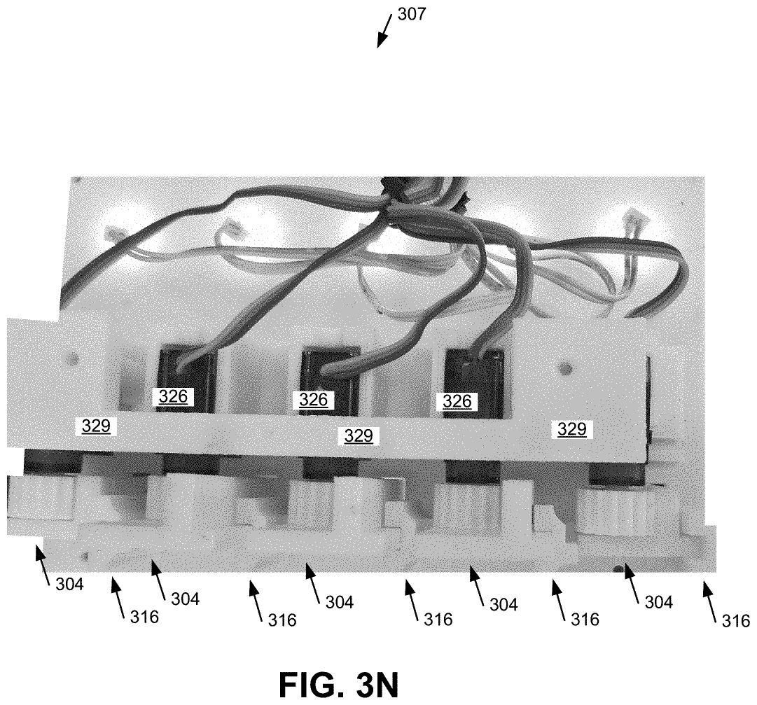

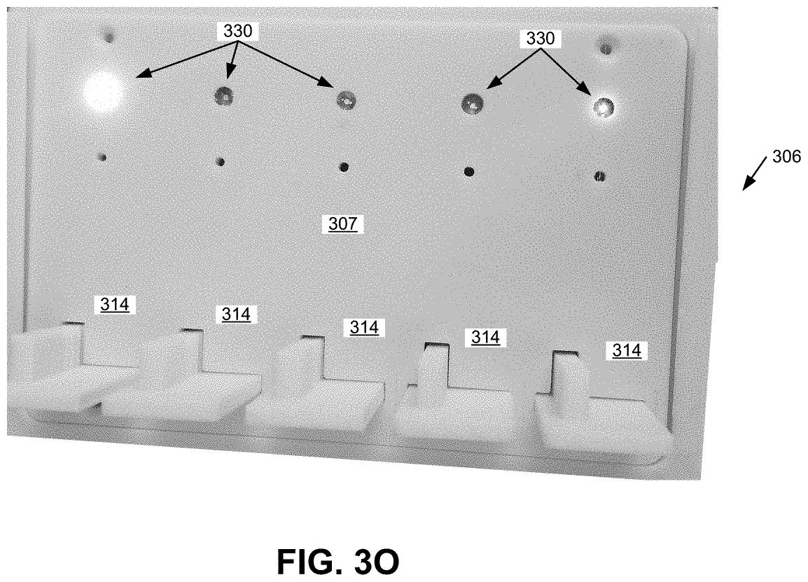

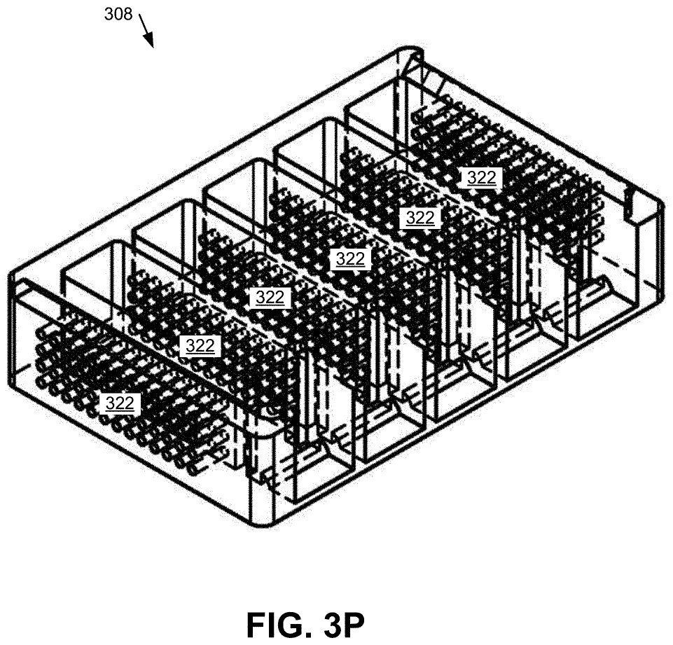

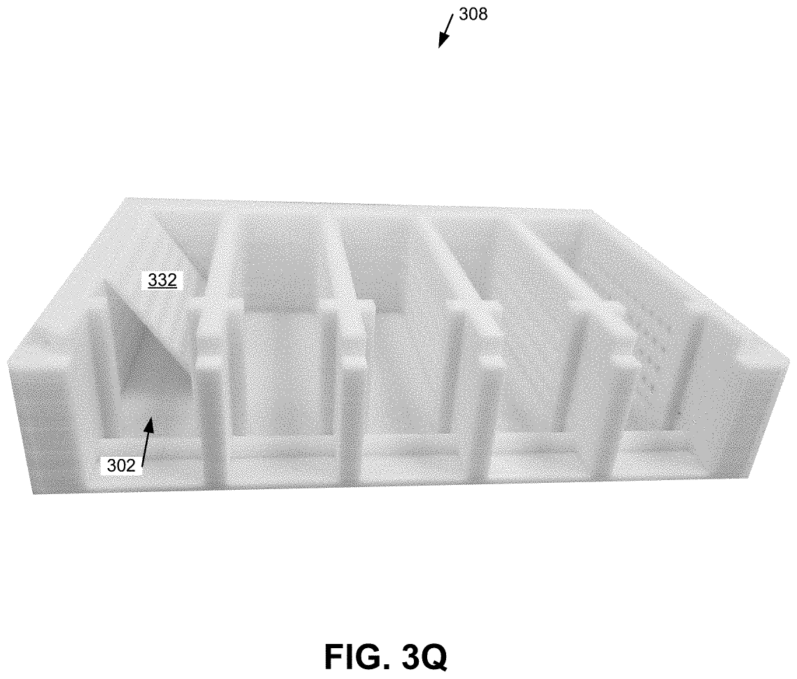

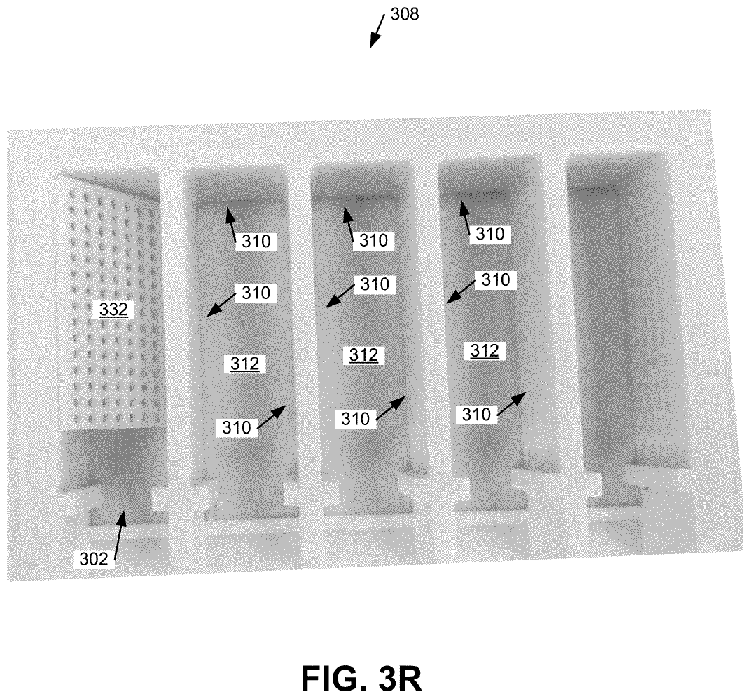

As described above, FIGS. 3A-3R illustrate various views of an implementation of an example automated feeder for live bait 300 according to the present disclosure. As shown in FIG. 3C, in some implementations, the automated feeder for live bait 300 comprises a plurality of cells or storage units 302 configured to house live bait such as crickets, worms, roaches, etc. In some implementations, each storage unit 302 comprises an automated door 304 that is configured to open in real-time or near real-time (e.g., based on a local or remote activation) or based on a pre-programmed time.

As shown in FIG. 3A, in some implementations, the automated feeder for live bait 300 comprises a top piece 306 and a bottom piece 308 that combine together to form the automated feeder for live bait 300 and can be separated apart (e.g., for maintenance as described below).

As shown in FIG. 3J, in some implementations, the automated feeder for live bait 300 comprises circuitry such as a computer system 320 that is configured to locally control the automated feeder for live bait 300.

As shown in FIG. 3O, in some implementations, the automated feeder for live bait 300 may further comprise one or more storage unit lights 330 to assist in dispersing (and/or attracting) live bait from (to) the storage units 302 (e.g. when the doors 304 are opened, as described below).

As shown in FIG. 3Q, in some implementations, the automated feeder for live bait 300 may further comprise one or more storage unit dividers 332 to further allow live bait to prop, rest, etc. within the storage units 302, as described below.

As shown in FIG. 3J, in some implementations, the automated feeder for live bait 300 may further comprise one or more fans 334 to circulate, ventilate, etc. air within the automated feeder for live bait 300, as described below.

In some implementations, the automated feeder for live bait 300 is configured to automatically feed live bait, such as crickets, worms, roaches, etc., to a reptile, amphibian, bird, or other pet that is fed live bait.

In some implementations, the automated feeder for live bait 300 is configured to house live bait. For example, in some implementations, each of the storage units 302 of the automated feeder for live bait 300 is configured to house live bait.

In some implementations, the automated feeder for live bait 300 is configured to maintain the live bait. For example, as shown in FIG. 3P, in some implementations, each of the storage units 302 of the automated feeder for live bait 300 comprises one or more breathing holes or other openings 322. In some implementations, the breathing holes or other openings 322 are configured to allow air into the storage units 302 for live bait housed in the storage units 302 to breathe.

In some implementations, the automated feeder for live bait 300 is configured to house food for the live bait. For example, in some implementations, each of the storage units 302 of the automated feeder for live bait 300 (such as shown in FIG. 3C) is configured to house food for the live bait.

In some implementations, the automated feeder for live bait 300 is configured so that live bait housed in the automated feeder for live bait 300 cannot exit the automated feeder for live bait 300 unless a respective automated door 304 of one of the storage units 302 is open. For example, in some implementations, each respective automated door 304 of the storage units 302 (such as shown in FIG. 3C) is configured to keep live bait in the storage units 302 when the automated door 304 is closed. Similarly, in some implementations, each respective automated door 304 of the storage units 302 is configured to allow live bait to exit or otherwise be removed from the storage units 302 when the automated door 304 is open. Furthermore, in some implementations, each respective automated door 304 of the storage units 302 is configured to allow live bait to be loaded or otherwise inserted into the storage units 302 when the automated door 304 is open.

In some implementations, the automated feeder for live bait 300 comprises a storage unit 302 for each of the number of days that the automated feeder for live bait 300 is configured to feed live bait to a pet. For example, as shown in FIG. 3C, in some implementations, an automated feeder for live bait 300 configured to feed live bait to a pet for five (5) days comprises five (5) storage units 302. Similarly, in some implementations, an automated feeder for live bait 300 configured to feed live bait to a pet for seven (7) days comprises seven (7) storage units 302. In some implementations, the automated feeder for live bait 300 may comprise any other suitable number of storage units 302. In some implementations, the number of storage units 302 that the automated feeder for live bait 300 comprises may be based on any other suitable quantity.

As shown in FIGS. 3A and 3F, in some implementations, the automated feeder for live bait 300 is rectangular box shaped. In some implementations, the automated feeder 300 may be any other suitable shape.

As shown in FIG. 3R, in some implementations, each storage unit 302 comprises one or more walls 310 and a floor 312. As shown in FIG. 3C, in some implementations, each storage unit 302 comprises a ceiling 314. As shown in FIG. 3N, in some implementations, each storage unit 302 comprises one or more door tracks 316.

As shown in FIGS. 3Q and 3R, in some implementations, the storage units 302 are rectangular box shaped. For example, in some implementations, walls 310, floor 312, ceiling 314, and automated door 304 of each respective storage unit 302 form a rectangular box shaped compartment or cell for holding live bait.

In some implementations, the storage units 302 may be any other suitable shape.

As shown in FIG. 3R, in some implementations, the walls 310 are rectangular panel shaped. In some implementations, the walls 310 may be any other suitable shape.

In some implementations, the walls 310 are positioned opposite facing, such as the walls 310 on the left and right sides of a respective storage unit 302. In some implementations, the walls 310 are positioned opposite facing a respective automated door 304, such as the walls 310 on the back side of a respective storage unit 302.

As shown in FIG. 3R, in some implementations, the walls 310 are configured to provide side surfaces of the storage unit 302. In some implementations, two adjacent storage units 302 may share one or more of the walls 310 between the adjacent storage units 302.

As shown in FIG. 3R, in some implementations, the floor 312 is rectangular panel shaped. In some implementations, the floor 312 may be any other suitable shape.

As shown in FIG. 3C, in some implementations, the floor 312 is positioned opposite facing a respective ceiling 314, such as at the bottom and top sides respectively of a respective storage unit 302.

As shown in FIG. 3R, in some implementations, the floor 312 is configured to provide a bottom surface of the storage unit 302.

As shown in FIG. 3C, in some implementations, the ceiling 314 is rectangular panel shaped. In some implementations, the ceiling 314 may be any other suitable shape.

In some implementations, the ceiling 314 is positioned opposite facing a respective floor 312, such as at the top and bottom sides respectively of a respective storage unit 302.

As shown in FIG. 3C, in some implementations, the ceiling 314 is configured to provide a top surface of the storage unit 302.

As shown in FIG. 3K, in some implementations, the door tracks 316 comprise a linear rail or guide shape. In some implementations, the door tracks 316 may comprise any other suitable shape.

In some implementations, the door tracks 316 are positioned opposite facing, such as on the left and right sides of a respective automated door 304.

As shown in FIG. 3N, in some implementations, the door tracks 316 are configured to guide an automated door 304 between an open position and a closed position with respect to a respective storage unit 302. In some implementations, the door tracks 316 are attached to a sub-top piece 307 of the top piece 306 (described below) and position adjacent to a respective storage unit 302. In some implementations, the door tracks 316 may have any other suitable configuration with respect to a respective storage unit 302.

As shown in FIG. 3D, in some implementations, the automated door 304 is rectangular panel shaped. In some implementations, the automated door 304 may be any other suitable shape.

In some implementations, the automated door 304 is positioned opposite facing a respective wall 310, such as the wall 310 on the back side of a respective storage unit 302.

In some implementations, each automated door 304 of the automated feeder for live bait 300 is configured to open in response to activating an actuator (e.g., pressing a button, not shown) on the automated feeder for live bait 300 or on a remote controller (e.g., a mobile device, desktop device, or other remote controller).

In some implementations, each automated door 304 of the automated feeder for live bait 300 is configured to open based on a pre-programmed or set time. For example, as shown in FIGS. 3D-3E, in some implementations, the automated feeder for live bait 300 is configured to be programmed to open any one or more of the automated doors 304 at a set time. In some implementations, each automated door 304 is configured to open based on a set time to allow live bait to exit or otherwise be removed from a respective storage unit 302 at the set time to feed the live bait to a reptile or other pet that is fed live bait.

As shown in FIG. 3N, in some implementations, each automated door 304 of the automated feeder for live bait 300 is opened and closed by an actuator or door mechanism 324. In some implementations, each respective door mechanism 324 is attached to a sub-top piece 307 of the top piece 306 (described below) and positions adjacent to a respective storage unit 302. In some implementations, each respective door mechanism 324 is also connected to a respective automated door 304.

As shown in FIG. 3M, in some implementations, each door mechanism 324 comprises a motor 326, a circular gear 327 (e.g., a pinion gear or cog), and a linear gear 328 (e.g., a rack gear). In some implementations, the circular gear 327 is rotationally connected to the motor 326 such that the motor 326 can rotate the circular gear 327. In some implementations, the linear gear 328 is attached to a respective automated door 304 such that linear movement of the linear gear 328 correspondingly moves the respective automated door 304 (e.g., to open or close the door 304).

In some implementations, the circular gear 327 is moveably engaged with the linear gear 328 such that rotational movement of the circular gear 327 by the motor 326 causes linear movement of the linear gear 328 and the attached respective automated door 304 to thereby open or close the door 304.

In some implementations, the door mechanism 324 may comprise a linear actuator. In some implementations, the door mechanism may comprise any other suitable components configured to open and close the automated door 304.

In some implementations, the door mechanism 324 is configured to open and close a respective automated door 304, such as in the manner described above or in any other suitable way.

As shown in FIG. 3H, in some implementations, the top piece 306 of the automated feeder for live bait 300 is at least substantially rectangular box shaped. In some implementations, the top piece 306 may be any other suitable shape.

As shown in FIGS. 3A and 3F, in some implementations, the top piece 306 is shaped such that it joins together with the bottom piece 308 to form the automated feeder for live bait 300.

In some implementations, the top piece 306 is configured to join together with the bottom piece 308 to form the automated feeder for live bait 300. For example, in some implementations, the top piece 306 is configured to join together with the bottom piece 308 by a coupling configuration and/or by fasteners. In some implementations, the top piece 306 is configured to join together with the bottom piece 308 in any other suitable way.

In some implementations, the top piece 306 of the automated feeder for live bait 300 is configured to house any circuitry, mechanisms, etc. of the automated feeder for live bait 300. For example, as shown in FIGS. 3J and 3M, in some implementations, the top piece 306 is configured to house the computer system 320 and the door mechanism 324.

In some implementations, the top piece 306 of the automated feeder for live bait 300 may comprise any such circuitry, mechanisms, etc. of the automated feeder for live bait 300.

As shown in FIG. 3O, in some implementations, the top piece 306 of the automated feeder for live bait 300 comprises a sub-top piece 307. As shown in FIG. 3K, in some implementations, the sub-top piece 307 is at least substantially rectangular panel shaped. In some implementations, the sub-top piece 307 may be any other suitable shape.

As shown in FIG. 3O, in some implementations, the sub-top piece 307 is shaped such that it forms a bottom side of the top piece 306, e.g. as part of the rectangular box shape that houses components of the automated feeder 300 as described above.

As shown in FIG. 3J, in some implementations, the sub-top piece 307 is configured to form a separable bottom side of the top piece 306. For example, in some implementations, the sub-top piece 307 is configured to be separable from the top piece 306 to allow access into the rectangular box shaped housing provided by the top piece 306.

In some implementations, the sub-top piece 307 is configured to connect to the top piece 306 by a coupling configuration and/or by fasteners. In some implementations, the sub-top piece 307 is configured to connect to the top piece 306 in any other suitable way.

In some implementations, the sub-top piece 307 is configured to hold (e.g. attached thereto) some of components that are housed by the top piece 306.

For example, as shown in FIG. 3M, in some implementations, the sub-top piece 307 is configured to hold the door mechanisms 324. As shown in FIG. 3N, in some implementations, the sub-top piece 307 may comprise a brace or bracket 329 that is configured to secure the motors 326 of the door mechanisms 324 to the sub-top piece 307.

As shown in FIG. 3N, in some implementations, the sub-top piece 307 is configured to hold the automated doors 304 and the door tracks 316. In some implementations, the sub-top piece 307 may be configured to hold any other suitable components of the automated feeder for live bait 300.

In some implementations, the top piece 306 of the automated feeder for live bait 300 comprises the ceiling 314 of each storage unit 302 of the automated feeder for live bait 300. For example, as shown in FIG. 3O, in some implementations, the bottom side of the sub-top piece 307 comprises the storage unit ceilings 314, i.e. when the top piece 306 and the bottom piece 308 are attached together to form the automated feeder for live bait 300.

As shown in FIG. 3R, in some implementations, the bottom piece 308 of the automated feeder for live bait 300 comprises the walls 310 and the floor 312 of each storage unit 302 of the automated feeder for live bait 300. In some implementations, the bottom piece 308 may comprise the storage units 302 of the automated feeder for live bait 300, including the walls 310, the floor 312, and the ceiling 314 of each storage unit 302.

As shown in FIG. 3P, in some implementations, the bottom piece 308 of the automated feeder for live bait 300 is at least substantially rectangular box shaped. In some implementations, the bottom piece 308 may be any other suitable shape.

As shown in FIGS. 3A and 3F, in some implementations, the bottom piece 308 is shaped such that it joins together with the top piece 306 to form the automated feeder for live bait 300.

In some implementations, the bottom piece 308 is configured to join together with the top piece 306 to form the automated feeder for live bait 300. For example, in some implementations, the bottom piece 308 is configured to join together with the top piece 306 by a coupling configuration and/or by fasteners. In some implementations, the bottom piece 308 is configured to join together with the top piece 306 in any other suitable way.

In some implementations, the bottom piece 308 of the automated feeder for live bait 300 is configured to be washable to clean up from the live bait. For example, in some implementations, the bottom piece 308 is configured to be separated from the top piece 306. In some implementations, this separation allows the bottom piece 308, which comprises components that form the storage units 302 that hold live bait, to be maintenanced, such as cleaned out, washed, etc.

Furthermore, in some implementations, the bottom piece 308 does not comprise circuitry, mechanisms, etc. (such as comprised by the top piece 306 as described above), which may be affected by such washing or other maintenance, to allow the bottom piece to be washed or otherwise maintenanced as described above.

In some implementations, the bottom piece 308 is composed of a plastic material that is washable. In some implementations, the bottom piece 308 is composed of any other suitable material that is washable.

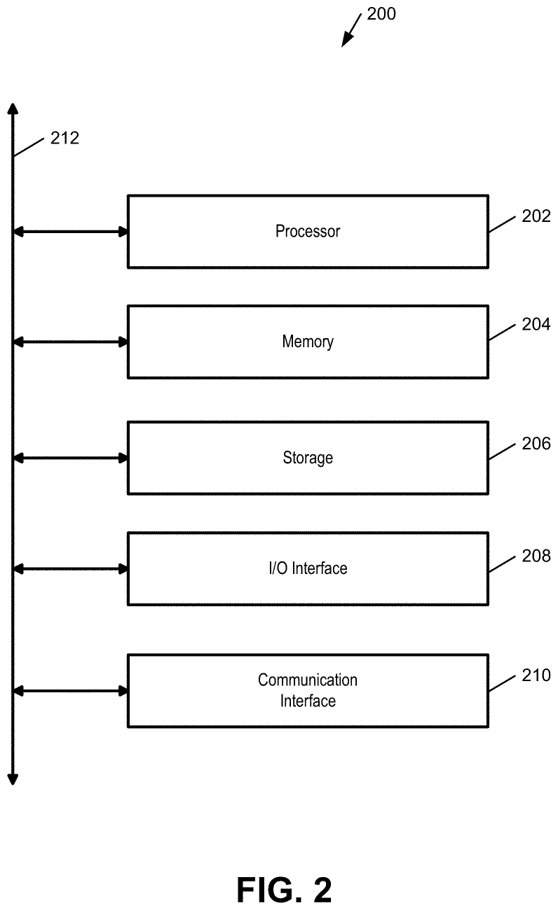

In some implementations, the computer system 320 of the automated feeder for live bait 300 is the same or similar to the computer system 200 described below for FIG. 2. For example, in some implementations, the computer system 320 may be a system-on-chip (SOC) computer system.

In some implementations, the computer system 320 is configured to operate the automated feeder for live bait 300. For example, in some implementations, the computer system 320 is configured to open or close a respective automated door 304 of one of the storage units 302.

In some implementations, the computer system 320 is configured to be programmed to automatically operate the automated feeder for live bait 300. For example, in some implementations, the computer system 320 is configured to be programmed to automatically open a respective automated door 304 of one of the storage units 302 at a set time to feed live bait from the storage unit 302 to a reptile or other pet that is fed live bait.

In some implementations, the computer system 320 is configured to interface with a local user interface (not shown) on the feeder 300 to locally operate and program the automatic operation of the automated feeder for live bait 300. In some implementations, the local user interface may comprise an input device such as a keypad. In some implementations, the local user interface may comprise a display. In some implementations, the local user interface may comprise any other suitable components.

In some implementations, the local user interface may be mounted on the automated feeder for live bait 300 to be accessible to a user. For example, in some implementations, the local user interface may be mounted on the top piece 306 of the automated feeder for live bait 300. In some implementations, the local user interface may be mounted on the automated feeder for live bait 300 in any other suitable location.

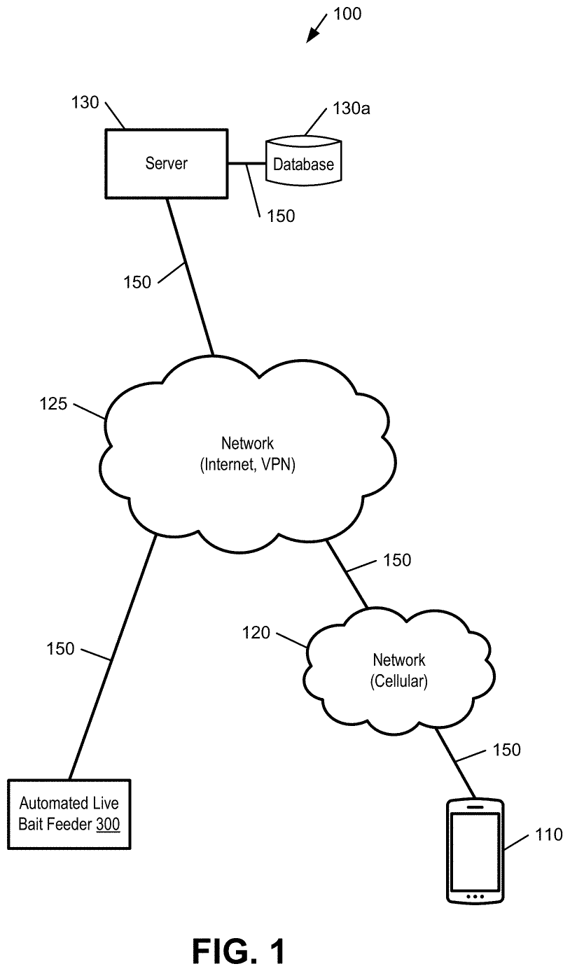

In some implementations, the computer system 320 is configured to interface with a computing device (such as the computing device 110 of FIG. 1, which may be portable or desktop) used to remotely operate and program the automatic operation of the automated feeder for live bait 300 through a mobile application or a software application (collectively “application”) on the computing device, as discussed above and as further discussed below for FIG. 1. In some implementations, the computer system 320 is configured to operate and program the automatic operation of the automated feeder for live bait 300 in response to remote communications from the computing device. In some implementations, the computer system 320 is configured to provide any other suitable functionality to the automated feeder for live bait 300.

In some implementations, the storage unit lights 330 comprise light-emitting diodes (LEDs). In some implementations, the lights 330 may comprise any other suitable light source.

As shown in FIG. 3C, in some implementations, the lights 330 are positioned on the ceilings 314 of the storage units 302 respectively. For example, as shown in FIG. 3O, in some implementations, the lights 330 are attached to the sub-top piece 307, which forms the storage unit ceilings 314, as described above.

In some implementations, one light 330 is attached to each ceiling 314 of the storage units 302 respectively. In some implementations, more than one light 330 may be attached to each ceiling 314. In some implementations, the lights 330 may be positioned and/or attached to any other suitable location of the automated feeder for live bait 300.

In some implementations, the lights 330 are configured to assist in dispersing (and/or attracting) live bait from (to) the storage units 302. For example, as shown in FIG. 3C, in some implementations, the lights 330 are configured to turn on in a respective storage unit 302 when the respective automated door 304 is open, such as to cause live bait to disperse from (and/or be attracted to) the storage unit 302. In some implementations, the lights 330 are configured to turn off in a respective storage unit 302 when the respective automated door 304 is closed.

In some implementations, the lights 330 may be configured to turn on and/or off by manual control. In some implementations, the lights 330 may be configured to turn on and/or off automatically. In some implementations, the lights 330 may be configured to turn on and/or off based on user programming, such as with respect to the type of live bait held in the storage units 302.

In some implementations, the lights 330 may be configured to turn on and/or off in any other suitable manner and/or for any other suitable condition with respect to the respective storage unit 302.

As shown in FIG. 3R, in some implementations, the storage unit dividers 332 may comprise a rectangular or other suitably shaped panel. As shown in FIGS. 3B, 3Q, and 3R, in some implementations, the dividers 332 are sized and/or shaped to position within the storage units 302, such as diagonally between the walls 310 and/or the ceiling 314 and the floor 312.

As shown in FIG. 3R, in some implementations, the dividers 332 may include holes or other openings that are similar to the openings 322 in the storage units 302, described above for FIG. 3P.

As shown in FIGS. 3B, 3Q, and 3R, in some implementations, the storage unit dividers 332 are configured to position within the storage units 302, such as diagonally between the walls 310 and/or the ceiling 314 and the floor 312. In some implementations, the dividers 332 are configured to be removable from and or repositionable within the storage units 302.

In some implementations, the dividers 332 are configured to further allow live bait to prop, rest, etc. within the storage units 302, such as to minimize crowding, unrest, etc. of the live bait within the storage units 302. For example, in some implementations, the dividers 332 are configured to provide additional surface area within the storage units 302 for live bait to prop, rest, etc. upon.

In some implementations, the dividers 332 may be configured to provide any other suitable features with respect to the storage units 302.

In some implementations, the fans 334 may comprise any suitable type, shape, size, etc. of fans, such as hardware case fans.

In some implementations, the fans 334 may be positioned in any suitable location of the automated feeder for live bait 300. For example, as shown in FIG. 3I, in some implementations, the fans 334 are positioned on the back side of the top piece 306 of the automated feeder for live bait 300.

As shown in FIG. 3G, in some implementations, the automated feeder for live bait 300 may further comprise fan openings 335, such as positioned on the back side of the top piece 306. As shown in FIG. 3I, in some implementations, the fans 334 may be positioned adjacent to the vents 335, such as to allow the fans 334 to pull air in and/or push air out of the automated feeder for live bait 300.

In some implementations, the automated feeder for live bait 300 may further comprise any other suitable openings, such as for air circulation, ventilation, etc., in any other suitable location of the automated feeder 300.

In some implementations, the fans 334 are configured to circulate, ventilate, etc. (“provide”) air within the automated feeder for live bait 300, such as to the storage units 302 and/or other components of the automated feeder for live bait 300. For example, in some implementations, the fans 334 may be configured to pull air in and/or push air out of one or more locations of the automated feeder for live bait 300, such as the storage units 302.

In some implementations, the fans 334 are configured to provide air within the automated feeder for live bait 300 to maintain the viability and/or increase the survivability of live bait held within the storage units 302. For example, in some implementations, the fans 334 are configured to provide ventilation to the live bait. In some implementations, the fans 334 are configured to maintain an acceptable temperature within the automated feeder 300 for the live bait.

In some implementations, the fans 334 may be configured to provide any other suitable features of the automated feeder for live bait 300.

In some implementations, the fans 334 may be configured to turn on and/or off by manual control. In some implementations, the fans 334 may be configured to turn on and/or off automatically. In some implementations, the fans 334 may be configured to turn on and/or off based on user programming, such as with respect to the type of live bait held in the storage units 302.

In some implementations, the fans 334 may be configured to turn on and/or off in any other suitable manner and/or for any other suitable conditions.

In some implementations, the automated feeder for live bait 300 comprises any suitable dimensions.

In some implementations, the automated feeder for live bait 300 is composed of any suitable materials, such as the materials described above.

In some implementations, the automated feeder for live bait 300 can have any suitable appearance.

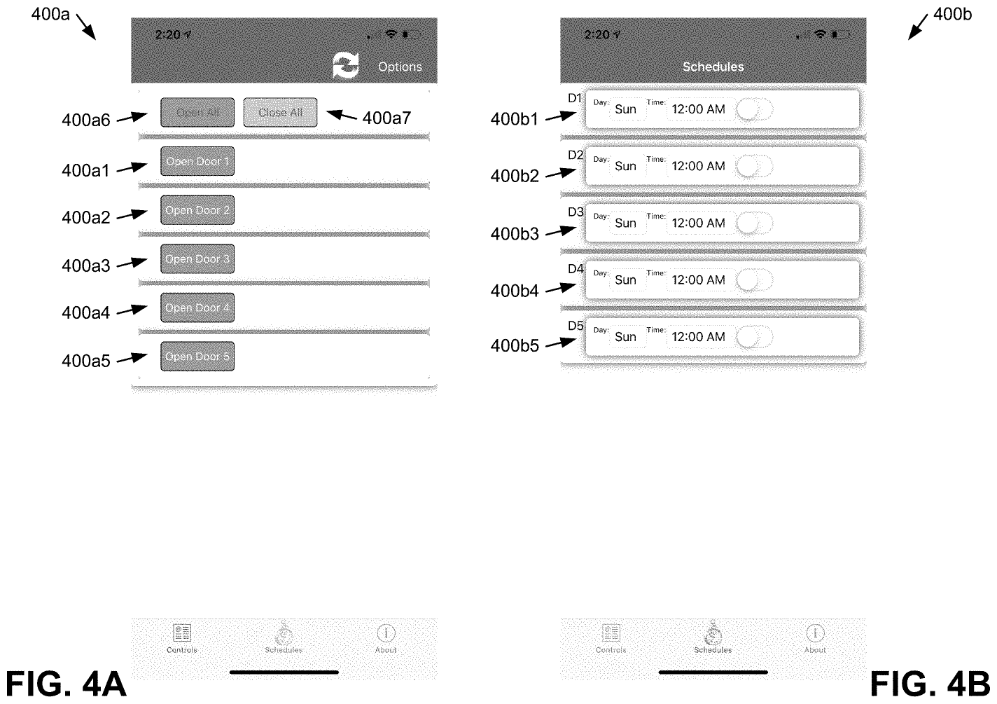

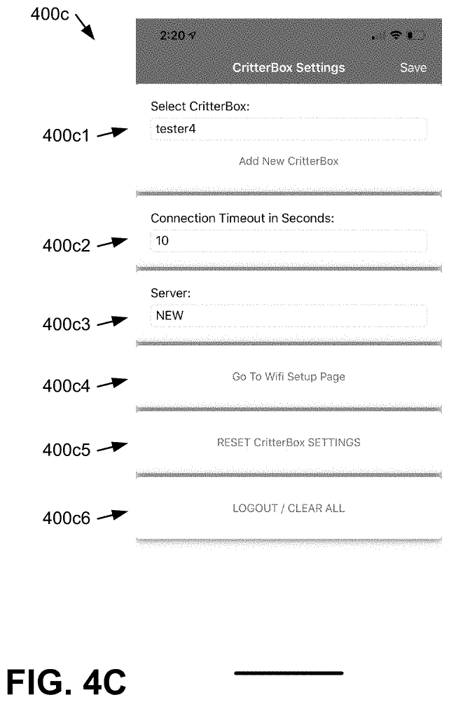

FIGS. 4A-4C illustrate implementations of example user interfaces 400a-c of a mobile application (or software application) for controlling an automated feeder for live bait, such as the automated feeder for live bait 300, according to the present disclosure.

In some implementations, the user interface 400a shown in FIG. 4A is a controls interface comprising a plurality of Open Door remote operation buttons 400a1-a5 corresponding to the number of automated doors of the automated feeder for live bait. For example, in some implementations, the Open Door button 400a1 remotely controls the operation of the automated door connected to the first door control output (e.g., “control output D1”) of the computer system 320, the Open Door button 400a2 controls the operation of the automated door connected to the second door control output (e.g., “control output D2”), and so on. In some implementations, a selection of one of the Open Door remote operation buttons 400a1-a5 remotely controls the opening of the corresponding automated door of the automated feeder for live bait.

As shown in FIG. 4A, the user interface 400a also comprises an Open All button 400a6 that remotely controls the operation of opening all of the automated doors in a similar manner/connection as described above for the individual Open Door buttons 400a1-a5.

In some implementations, the above described Open Door remote operation buttons 400a1-a5 are further configured to remotely control the closing of the corresponding automated door of the automated feeder for live bait.

As shown in FIG. 4A, the user interface 400a also comprises a Close All button 400a7 that remotely controls the operation of closing all of the automated doors in a similar manner/connection as described above for the individual Open Door buttons 400a1-a5.

In some implementations, the user interface 400a may further comprise any other suitable buttons or other interfaces that remotely control operations of the automated feeder for live bait.

In some implementations, the user interface 400a may be configured to use for a release/feeding mode and/or a loading mode with respect to live bait in the automated feeder.

In some implementations, the user interface 400b shown in FIG. 4B is a schedules interface comprising a plurality of remote operation schedule settings 400b1-b5 corresponding to the number of automated doors of the automated feeder for live bait. For example, in some implementations, the remote operation schedule settings 400b1 remotely sets a Day, Time, and/or On/Off schedule settings of the automated door connected to the first door schedule output (e.g., “schedule output D1”) of the computer system 320, the remote operation schedule settings 400b2 remotely sets a Day, Time, and/or On/Off schedule settings of the automated door connected to the second door schedule output (e.g., “schedule output D2”), and so on. In some implementations, a setting of one of the remote operation schedule settings 400b1-b5 remotely schedules the opening of the corresponding automated door of the automated feeder for live bait.

In some implementations, the above described remote operation schedule settings 400b1-b5 are further configured to remotely schedule the closing of the corresponding automated door of the automated feeder for live bait.

In some implementations, the user interface 400b may further comprise any other suitable settings or other interfaces that remotely schedule operations of the automated feeder for live bait.

In some implementations, the user interface 400b may be configured to use for a scheduled release/feeding mode with respect to live bait in the automated feeder.

In some implementations, the user interface 400c shown in FIG. 4C is a settings interface comprising a plurality of remote settings 400c1-c6. For example, in some implementations, the device selection input field 400c1 corresponds to the device identification of the automated feeder for live bait to be controlled and/or programmed. In some implementations, the connection timeout input field 400c2 corresponds to the desired connection timeout period (e.g., in seconds) between the computing device and the automated feeder for live bait

In some implementations, the server selection input field 400c3 corresponds to a server identification with respect to controlling, programming, etc. the automated feeder for live bait. In some implementations, the selection 400c4 opens a WiFi setup page of the mobile application.

In some implementations, the selection 400c5 causes the mobile application to reset the above described settings 400c1-c3 and/or other settings of the mobile application. In some implementations, the selection 400c6 causes the mobile application to logout and/or clear all connections.

In some implementations, the user interface 400c may further comprise any other suitable settings or other interfaces for remotely setting the automated feeder for live bait.

In some implementations, the above described local user interface comprises one or more user interfaces that are substantially the same or similar to the above described user interfaces 400a-c of FIGS. 4A-4C.

In some implementations, an example method of using the automated feeder for live bait 300 is performed remotely using the mobile application on a portable computing device (or a software application on a desktop computing device) or locally using the local user interface. In some implementations, the method comprises loading one or more of the storage units 302 with live bait by opening and closing the corresponding automated doors 304 to load and hold the live bait.

In some implementations, the automated doors 304 are opened and closed locally using the local user interface.

In some implementations, the automated doors 304 are opened and closed using the mobile application (or software application) by selecting the corresponding Open Door remote operation buttons 400a1-a5 as described above with respect to the user interface 400a shown in FIG. 4A.

In some implementations, the method comprises feeding the loaded live bait from one or more of the storage units 302 to a pet by opening the corresponding automated doors 304 to release the live bait to the pet.

In some implementations, the automated doors 304 are opened using the mobile application by selecting the corresponding Open Door remote operation buttons 400a1-a5 as described above with respect to the user interface 400a shown in FIG. 4A.

In some implementations, the automated doors 304 are programmed to automatically open at a set time to feed the live bait to the pet. For example, in some implementations, the automated feeder for live bait 300 is programmed to open one or more of the automated doors 304 at a respective set day and time using the remote operation schedule settings 400b1-b5 as described above with respect to the user interface 400b shown in FIG. 4B.

In some implementations, one automated door 304 may be programmed to open each day to release the live bait from the respective storage unit 302 to feed the pet. In some implementations, the automated doors 304 may be programmed to open in any other suitable combination, such as two or three doors at a time. In some implementations, the automated doors 304 may be programmed to open at any other suitable time interval, such as twice a day or every other day.

FIG. 1 illustrates an implementation of an example environment 100 of an automated feeder for live bait 300 according to the present disclosure.

As shown in FIG. 1, in some implementations, the environment 100 may include an automated feeder for live bait 300, one or more client devices 110, a wireless cellular network 120, a network 125, and, in some implementations, a server 130. In some implementations, the example environment 100 also may include one or more data storage 130a1 linked to the server 130.

As discussed above, in some implementations, a client device 110 may be used by users of the automated feeder for live bait 300 to remotely operate and/or program the automated feeder for live bait 300 of the present disclosure discussed above. In some implementations, the programs and other inputs described above may be stored in data storage 130a1 via server 130.

The client device 110 is depicted as a mobile phone, but the client device 110 may comprise any type of computing device, such as a desktop computer system, a laptop, cellular phone, a smart device, a mobile telephone, a tablet-style computer, or any other device capable of wireless or wired communication. In some implementations, client device 110 is configured to interact with the server 130 via an application, such as a web browser or a native application, residing on the client device 110.

In some implementations, the client devices 110 includes hardware, software, or embedded logic components or a combination of two or more such components and is configured to carry out the appropriate functions implemented or supported by the client devices 110.

In some implementations, the client devices 110 may include one or more processors, one or more memories, one or more displays, one or more interfaces, one or more components capable of inputting data, one or more components capable of outputting data, one or more components capable of communicating with any other component of the environment 100 of the automated feeder for live bait 300, or any other component suitable for a particular purpose.

In some implementations, the client devices 110 are configured to access networks 120 and/or 125. In some implementations, the client devices 110 are configured to communicate with server 130 or directly or indirectly with feeder 300. In some implementations, server 130 is configured to communication with feeder 300. In some implementations, instructions from client device 110 are transmitted to feeder 300 without the use of a remote server 130. In some implementations, instructions from client device 110 are transmitted to feeder 300 via a remote server 130.

In some implementations, the client device 110 can connect to the network 125 through a wireless cellular network 120, such as GPRS-based and CDMA-based wireless networks, as well as 802.16 WiMax and long-range wireless data networks. In some implementations, the client device 110 does not connect to the network 125 through a wireless cellular network 120.

In some implementations, components of the environment 100 may communicate with any other component of the environment 100 over network 125. Network 125 may be any suitable network. In some implementations, for example, one or more portions of network 125 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another network 125, or a combination of two or more of the foregoing.

In some embodiments, components of the environment 100 may be configured to communicate over links 150. Links 150 may connect components of the environment 100 to networks 120, 125 or to each other. In some implementations, one or more links 150 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links 150. Links 150 may not be the same throughout the environment 100.

In some implementations, the server device 130 may include a processor, memory, user accounts, and one or more modules to perform various functions such as those described above.

In some implementations, server 130 may be a unitary server or may be a distributed server spanning multiple computers or multiple datacenters. Server 130 may be of various types, such as, for example and without limitation, web server, file server, application server, exchange server, database server, or proxy server. In some implementations, server 130 may include hardware, software, or embedded logic components or a combination of two or more such components for carrying out the appropriate functionalities implemented or supported by server 130. For example, a web server is generally capable of hosting websites containing web pages or particular elements of web pages. More specifically, a web server may host HTML files or other file types, or may dynamically create or constitute files upon a request, and communicate them to clients 110 in response to HTTP or other requests from clients 110. A database server is generally capable of providing an interface for managing data stored in one or more data stores.

In some implementations, data storage 130a may be communicatively linked to server 130 via link 150. In some implementations, data storage 130a may be used to store various types of information (e.g., programs or other information described above). In some implementations, the information stored in data storage 130a may be organized according to specific data structures. In particular embodiment, data storage 130a may be a relational database. Particular embodiments may provide interfaces that enable servers 130 or clients 110 to manage, e.g., retrieve, modify, add, or delete, the information stored in data storage 130a.

FIG. 2 illustrates an example computer system 200, which may be used with some implementations of the present invention. This disclosure contemplates any suitable number of computer systems 200.

This disclosure contemplates computer system 200 taking any suitable physical form. In some implementations, as an example and not by way of limitation, computer system 200 may be an embedded computer system, a system-on-chip (SOC), a single-board computer system (SBC) (such as, for example, a computer-on-module (COM) or system-on-module (SOM)), a desktop computer system, a laptop, an interactive kiosk, a mainframe, a mesh of computer systems, a mobile telephone, a personal digital assistant (PDA), a server, or a combination of two or more of these.

In some implementations, where appropriate, computer system 200 may include one or more computer systems 200; be unitary or distributed; span multiple locations; span multiple machines; or reside in a cloud, which may include one or more cloud components in one or more networks.

In some implementations, where appropriate, one or more computer systems 200 may perform without substantial spatial or temporal limitation one or more steps of one or more methods described or illustrated herein. In some implementations, as an example and not by way of limitation, one or more computer systems 200 may perform in real time or in batch mode one or more steps of one or more methods described or illustrated herein. In some implementations, one or more computer systems 200 may perform at different times or at different locations one or more steps of one or more methods described or illustrated herein, where appropriate.

In some implementations, computer system 200 includes a processor 202, memory 204, storage 206, an input/output (I/O) interface 208, a communication interface 210, and a bus 212. Although this disclosure describes and illustrates a particular computer system having a particular number of particular components in a particular arrangement, this disclosure contemplates any suitable computer system having any suitable number of any suitable components in any suitable arrangement.

In some implementations, processor 202 includes hardware for executing instructions, such as those making up a computer program. In some implementations, as an example and not by way of limitation, to execute instructions, processor 202 may retrieve (or fetch) the instructions from an internal register, an internal cache, memory 204, or storage 206; decode and execute them; and then write one or more results to an internal register, an internal cache, memory 204, or storage 206.

In some implementations, processor 202 may include one or more internal caches for data, instructions, or addresses. The present disclosure contemplates processor 202 including any suitable number of any suitable internal caches, where appropriate. In some implementations, as an example and not by way of limitation, processor 202 may include one or more instruction caches, one or more data caches, and one or more translation look-aside buffers (TLBs).

In some implementations, instructions in the instruction caches may be copies of instructions in memory 204 or storage 206, and the instruction caches may speed up retrieval of those instructions by processor 202.

In some implementations, data in the data caches may be copies of data in memory 204 or storage 206 for instructions executing at processor 202 to operate on; the results of previous instructions executed at processor 202 for access by subsequent instructions executing at processor 202 or for writing to memory 204 or storage 206; or other suitable data.

In some implementations, the data caches may speed up read or write operations by processor 202. In some implementations, the TLBs may speed up virtual-address translation for processor 202.

In some implementations, processor 202 may include one or more internal registers for data, instructions, or addresses. The present disclosure contemplates processor 202 including any suitable number of any suitable internal registers, where appropriate. Where appropriate, processor 202 may include one or more arithmetic logic units (ALUs); be a multi-core processor; or include one or more processors 202. Although this disclosure describes and illustrates a particular processor, this disclosure contemplates any suitable processor.

In some implementations, memory 204 includes main memory for storing instructions for processor 202 to execute or data for processor 202 to operate on. In some implementations, as an example and not by way of limitation, computer system 200 may load instructions from storage 206 or another source (such as, for example, another computer system 200) to memory 204.

In some implementations, processor 202 may then load the instructions from memory 204 to an internal register or internal cache. In some implementations, to execute the instructions, processor 202 may retrieve the instructions from the internal register or internal cache and decode them.

In some implementations, during or after execution of the instructions, processor 202 may write one or more results (which may be intermediate or final results) to the internal register or internal cache. In some implementations, processor 202 may then write one or more of those results to memory 204.

In some implementations, processor 202 executes only instructions in one or more internal registers or internal caches or in memory 204 (as opposed to storage 206 or elsewhere) and operates only on data in one or more internal registers or internal caches or in memory 204 (as opposed to storage 206 or elsewhere).

In some implementations, one or more memory buses (which may each include an address bus and a data bus) may couple processor 202 to memory 204. In some implementations, bus 212 may include one or more memory buses, as described below.

In some implementations, one or more memory management units (MMUs) reside between processor 202 and memory 204 and facilitate accesses to memory 204 requested by processor 202.

In some implementations, memory 204 includes random access memory (RAM). In some implementations, this RAM may be volatile memory, where appropriate.

In some implementations, where appropriate, this RAM may be dynamic RAM (DRAM) or static RAM (SRAM). Moreover, in some implementations, where appropriate, this RAM may be single-ported or multi-ported RAM. The present disclosure contemplates any suitable RAM.

In some implementations, memory 204 may include one or more memories 204, where appropriate. Although this disclosure describes and illustrates particular memory, this disclosure contemplates any suitable memory.

In some implementations, storage 206 includes mass storage for data or instructions. In some implementations, as an example and not by way of limitation, storage 206 may include an HDD, a floppy disk drive, flash memory, an optical disc, a magneto-optical disc, magnetic tape, or a Universal Serial Bus (USB) drive or a combination of two or more of these.

In some implementations, storage 206 may include removable or non-removable (or fixed) media, where appropriate. In some implementations, storage 206 may be internal or external to computer system 200, where appropriate. In some implementations, storage 206 is non-volatile, solid-state memory.

In some implementations, storage 206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 206 taking any suitable physical form.

In some implementations, storage 206 may include one or more storage control units facilitating communication between processor 202 and storage 206, where appropriate. In some implementations, where appropriate, storage 206 may include one or more storages 206. Although this disclosure describes and illustrates particular storage, this disclosure contemplates any suitable storage.

In some implementations, I/O interface 208 includes hardware, software, or both providing one or more interfaces for communication between computer system 200 and one or more I/O devices. In some implementations, computer system 200 may include one or more of these I/O devices, where appropriate.

In some implementations, one or more of these I/O devices may enable communication between a person and computer system 200. In some implementations, as an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these.

In some implementations, an I/O device may include one or more sensors. This disclosure contemplates any suitable I/O devices and any suitable I/O interfaces 208 for them.

In some implementations, where appropriate, I/O interface 208 may include one or more device or software drivers enabling processor 202 to drive one or more of these I/O devices. I/O interface 208 may include one or more I/O interfaces 208, where appropriate. Although this disclosure describes and illustrates a particular I/O interface, this disclosure contemplates any suitable I/O interface.

In some implementations, communication interface 210 includes hardware, software, or both providing one or more interfaces for communication (such as, for example, packet-based communication) between computer system 200 and one or more other computer systems 200 or one or more networks.

In some implementations, as an example and not by way of limitation, communication interface 210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 210 for it.

In some implementations, as an example and not by way of limitation, computer system 200 may communicate with an ad hoc network, a personal area network (PAN), a local area network (LAN), a wide area network (WAN), a metropolitan area network (MAN), or one or more portions of the Internet or a combination of two or more of these.

In some implementations, one or more portions of one or more of these networks may be wired or wireless. In some implementations, as an example, computer system 200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these.

In some implementations, computer system 200 may include any suitable communication interface 210 for any of these networks, where appropriate. In some implementations, communication interface 210 may include one or more communication interfaces 210, where appropriate. Although this disclosure describes and illustrates a particular communication interface, this disclosure contemplates any suitable communication interface.

In some implementations, bus 212 includes hardware, software, or both coupling components of computer system 200 to each other. In some implementations, as an example and not by way of limitation, bus 212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these.

In some implementations, bus 212 may include one or more buses 212, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. In some implementations, as an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate.

Herein, reference to a computer-readable storage medium excludes any medium that is not eligible for patent protection under 35 U.S.C. § 101. Herein, reference to a computer-readable storage medium excludes transitory forms of signal transmission (such as a propagating electrical or electromagnetic signal per se) to the extent that they are not eligible for patent protection under 35 U.S.C. § 101.

This disclosure contemplates one or more computer-readable storage media implementing any suitable storage. In some implementations, a computer-readable storage medium implements one or more portions of processor 202 (such as, for example, one or more internal registers or caches), one or more portions of memory 204, one or more portions of storage 206, or a combination of these, where appropriate.

In some implementations, a computer-readable storage medium implements RAM or ROM. In some implementations, a computer-readable storage medium implements volatile or persistent memory.

In some implementations, one or more computer-readable storage media embody software. Herein, reference to software may encompass one or more applications, bytecode, one or more computer programs, one or more executables, one or more instructions, logic, machine code, one or more scripts, or source code, and vice versa, where appropriate.

In some implementations, software includes one or more application programming interfaces (APIs). This disclosure contemplates any suitable software written or otherwise expressed in any suitable programming language or combination of programming languages.

In some implementations, software is expressed as source code or object code. In some implementations, software is expressed in a higher-level programming language, such as, for example, C, Perl, or a suitable extension thereof. In some implementations, software is expressed in a lower-level programming language, such as assembly language (or machine code).

In some implementations, software is expressed in JAVA. In some implementations, software is expressed in Hyper Text Markup Language (HTML), Extensible Markup Language (XML), or other suitable markup language.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example. it will apparent to one of ordinary skill in the art that the invention may be used with any electronic network service, even if it is not provided through a website.

Any computer-based system that provides networking functionality can be used in accordance with the present invention even if it relies, for example, on email, instant messaging or other forms of peer-to-peer communications, and any other technique for communicating between users. The invention is thus not limited to any particular type of communication system, network, protocol, format or application.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

While the foregoing processes and mechanisms can be implemented by a wide variety of physical systems and in a wide variety of network and computing environments, the server or computing systems described below provide example computing system architectures for didactic, rather than limiting, purposes.

The present invention has been explained with reference to specific embodiments. For example, while embodiments of the present invention have been described as operating in connection with a network system, the present invention can be used in connection with any communications facility that allows for communication of messages between users, such as an email hosting site. Other embodiments will be evident to those of ordinary skill in the art. It is therefore not intended that the present invention be limited, except as indicated by the appended claims.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

The present disclosure encompasses all changes, substitutions, variations, alterations, and modifications to the example embodiments herein that a person having ordinary skill in the art would comprehend.

The figures, including photographs and drawings, comprised herewith may represent one or more implementations of the automated feeder for live bait.

Details shown in the figures, such as dimensions, descriptions, etc., are exemplary, and there may be implementations of other suitable details according to the present disclosure.

Reference throughout this specification to “an embodiment” or “implementation” or words of similar import means that a particular described feature, structure, or characteristic is comprised in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. An automated live bait feeder comprising:
a top portion comprising circuitry and mechanisms for controlling the automated live bait feeder;
a bottom portion positioned below the top portion and detachable from the top portion wherein the bottom portion comprises a plurality of storage units configured to separately house live bait; and
a plurality of automated doors for the plurality of storage units respectively, wherein the automated doors are configured to separately open and close in response to activating a respective mechanism, wherein each automated door is configured to close a respective opening leading to the outside of the automated live bait feeder to contain the live bait in the respective storage unit when the door is closed, and wherein each automated door is configured to open the respective opening leading to the outside of the automated live bait feeder so that live bait can exit the respective storage unit when the automated door is opened.
